(19) United States
(12) Patent Application Publication
(10) Pub. No.: US 2005/0045847 A1
(43) Pub. Date: Mar. 3, 2005

(54) Key operational valve

(76) Inventor: Douglas H. Powell, El Macero, CA (US)

Correspondence Address: Mark C. Jacobs, Esq., 3033 El Camino Avenue, Sacramento, CA, 95821-6014, US

(21) Appl. No.: 10/927,986

(22) Filed: Aug. 25, 2004

Related U.S. Application Data
(60) Provisional application No. 60/497,496, filed on Aug. 25, 2003.

(51) Int. Cl. F16K 1/00; F16K 15/00; F16K 3/00; F02B 1/00

(52) U.S. Cl. 251/319; 251/326

(57) ABSTRACT

A totally open-totally closed valve leakproof shut off device, suitable for backflow prevention, to terminate fluid flow, which comprises a virtual or real keyway between aligned opposite flanges with central openings; said keyway having a lateral opening greater than the lateral dimension of said flange openings. A pair of seated annular seals on opposite sides of the keyway; extend slightly into the keyway to touch each other such that when no key is inserted, fluid flows without leakage; and when a segregable key is inserted into the keyway, it slides between the two seals and closes off the opening of the keyway in a leakproof manner. The device is adaptable for large valves by utilizing retaining means such as hasps and fingers to removably retain the key in place, and by disposing the key internally in a housing from which removal can be achieved by use of an actuator.

### FIELD OF THE INVENTION

This application discloses and claims subject matter disclosed in my earlier filed provisional application, Ser. No. 60,497,496 filed Aug. 25, 2003.

### BACKGROUND OF THE INVENTION

This application relates to a uniquely new type of valve. The improvement to the valve art of this invention finds utility particularly in the field of backflow prevention valves. Backflow prevention means have evolved over the years through several generations. Backflow prevention valve systems include relief valves, shutoff valves, and check valves in various combinations.

Since 1960, there have been four generations of backflow valves. The first generation consisted essentially of the combination of a shutoff valve, connected to a check valve to a mirror image second set of these two with a relief valve in a tee between the two check valves. Reference is made to FIG. 1. These three combinations of elements were made by a plethora of manufacturers in various designs. One such maker was ClaVal.

The second generation combined the two check valves into one housing. One maker of such products was Febco.

Generation three, the next evolution, utilized a shutoff valve, a single housing with two ports in order to be able to gain access to each of the two check valves, a shutoff valve, and a relief valve which hang off the bottom. Again, reference is made to FIG. 1. Typical of such units was the 909 series made by Watts.

The market then decided that it wanted to have the relief valve in the main valve housing. Thus the next combination was a shutoff valve, a housing having two check valves, and a relief valve, followed by another shutoff valve. The Watts series 009 is a good example of this class, or generation of backflow prevention valves. Again, see FIG. 1.

The invention accordingly comprises the device possessing the features, properties, and the selection of components which are exemplified in the following detailed disclosure, and the scope of the application of which will be indicated in the appended claims.

For a fuller understanding of the nature and objects of the invention, reference should be made to the following detailed description, taken in conjunction with the accompanying drawings.

### SUMMARY

A backflow prevention shutoff valve system for use in small and large water systems such as office building and shopping centers wherein control of the valve system by maintenance personnel is essential, is disclosed. The valve system may be of various configurations wherein at least one of the valves is operated by removable segregable knife or key.

Both terms are appropriate because the closure of the valve is carried out by the insertion of a flat member into a socket, much like a knife being placed in a scabbard. Since the closure member also has a gripping area that resembles a key and the closure member opens or closes the valve, the term key is also appropriate for the closure member. The key employed is totally segregable from a keyway.

It is a first object to provide a key-operated backflow prevention valve system.

It is a second object to provide a backflow prevention valve system that utilizes one or more component valves operated by key closure.

It is a third object to provide a multi valve system whose components can be positioned geometrically differently according to space limitations for ease of operation.

These and other objects will in part be obvious and will in part become discernible from a reading of the specification and the appended claims.

### BRIEF DESCRIPTION OF THE FIGURES

FIG. 1 is a diagrammatic depiction of the four generations of backflow control valves.

FIG. 2 is an exploded view of the components forming the first embodiment of the valve system of this invention.

FIG. 3 is a plan view of a key constituting one component of this invention's first embodiment shown in a keyway also used in this invention.

FIG. 4 is a sectional view of a valve according to this invention's first embodiment in closed position, with the key in an inserted position.

FIG. 5 is a sectional view of the same valve in the open position with the key in a removed position.

FIG. 6 is an end view of a valve according to this invention with the key in a full open condition.

FIG. 7 is a top perspective view showing a first or left valve in open position and a second or right valve in a closed position.

FIG. 8 is a top perspective view of a dual line valve control system using a single valve.

FIGS. 9A-9D illustrate the versatility of placement of the valve closure of this invention.

FIG. 10 is a perspective view showing a plurality of valves according to this invention installed as a single fluid line with various components disposed in different directions for the saving of space and versatility.

FIGS. 11A-11C are perspective views that illustrate three consecutive moments in time in the closing of a heavy-duty valve according to this intention.

FIG. 12 is a side elevational view of an alternate configuration of the key component of this invention.

FIG. 13 is a top sectional view of the second embodiment of this invention.

FIG. 14 is an elevational view of a keyway for the second embodiment hereof.

FIG. 15 is an elevational view of the proximal or interior end of a flange of the second embodiment of this invention.

FIG. 16 is a perspective view of a third embodiment of this invention, which utilizes a virtual keyway.

FIG. 17 is an elevational view of the interior end of the flange of the third embodiment of this invention.

FIG. 18 is a top sectional view of the third embodiment of the invention.

FIG. 19 depicts one cosmetic form of the rear face of a key for the second and third embodiments of this invention.

FIG. 20 is a plan view that depicts the front face of a key and the interior of one flange of the third embodiment hereof, prior to insertion of the key into the virtual keyway.

FIG. 21 is a view similar to FIG. 20, but at a later moment in time, after the key has been inserted into the virtual keyway.

FIG. 22 is a view similar to FIG. 17, but with the buildup in a generally horizontal direction removed to create a two-way entry slot.

FIG. 23 is a perspective view of a flange according to embodiments 2 and 3 that incorporates a stem to receive a test cock.

### DESCRIPTION OF THE PREFERRED EMBODIMENT

Twelve figures are found in this application and each will de discussed at least briefly. FIG. 1 being a prior art history was discussed in the Background of the Invention.

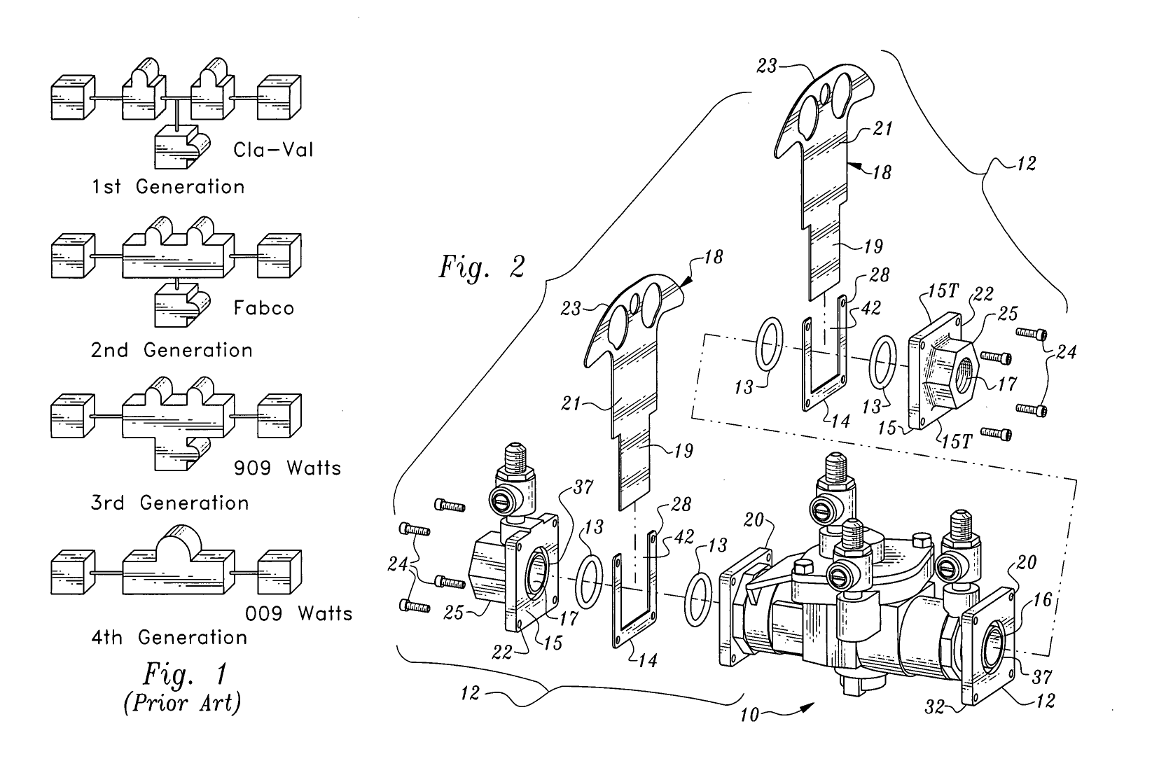

In the invention at hand, the shutoff valve is located in the main valve unit, so that it is all in one housing. Reference is now made to FIG. 2, wherein the invention 10 is seen. Here main valve body 11 integrates the pair of shutoff valves 12 at opposite ends of the main valve body 11. These shutoff valves 12 which form the heart of the invention are shown in an exploded view format. Flange 32 is a preferably square corner inner flange with a threaded bore 20 in each corner, and having a central opening 16 for water flow. A U-shaped keyway 14 having a central opening 42 sized to match the width and height of the flange 32 is interposed between a pair of O-rings 13. Each O-ring extends slightly laterally into the keyway central opening whereby the opposed O-rings touch each other when fluid is flowing. The keyway 14 has four apertures, 28, IE, one at both ends of each arm of the U-shaped keyway. A second and similarly sized flange 32 outer flange 15 has a set of non-threaded throughbores 22, one in each corner and it 15, also has a central opening 17. Nut 25 engages the threads 15T of the flange 15, or said nut may be formed in place on the flange plate 15. The assemblage is held together by a series of bolts 24 which pass through the throughbores 22, through the bores 28 of the keyway and each engages the respective threaded bore 20 of the first flange 32.

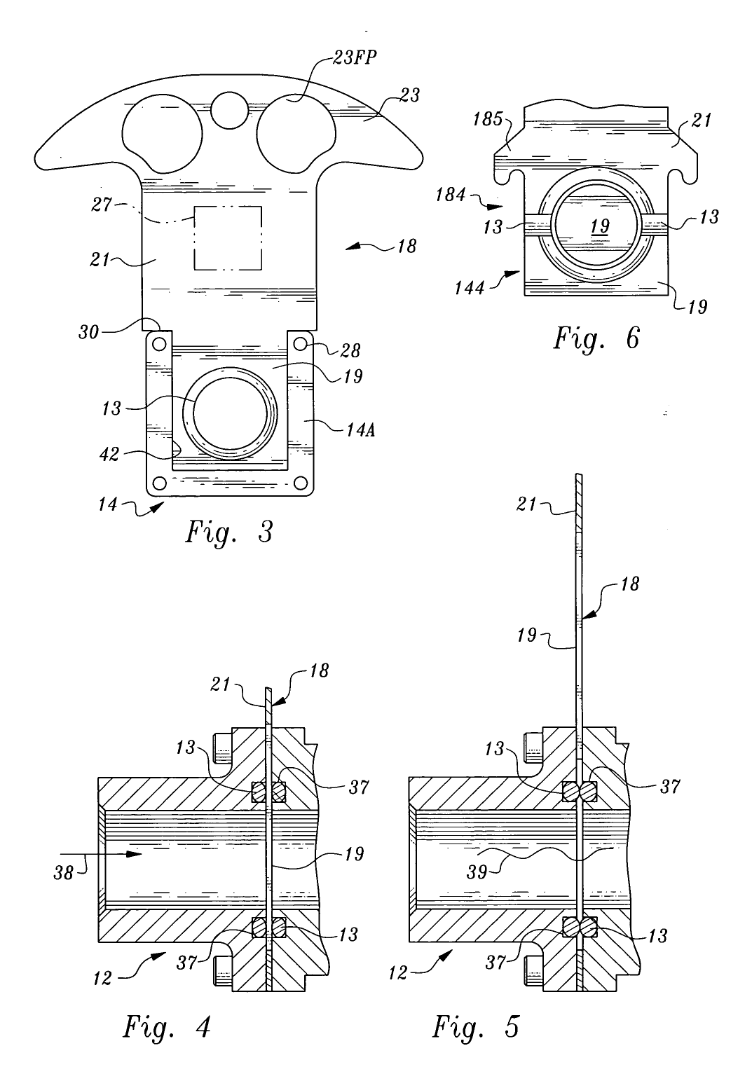

Thus the keyway 14 is retained between flanges 32 and 15, and the O-rings are seated in the flange openings respectively. The O-rings are seen between arms 14A as per FIG. 3.

The key 18 is the primary component of this invention and is shown in elevation in cosmetically different embodiments in FIGS. 2&3. The key 18 has three parts, a bottom flat square cornered part 19 sized to fit in U-shaped keyway 14—as seen in FIG. 3; a middle extension part 21, which can contain decoration or other indicia, such as cutouts or logos as seen in the embodiment again shown in FIG. 3; and a middle part 21 having decoration 27 thereon which is external at all times to the flow of fluid. The third part is a handle 23 which may include optional finger openings 23FP as shown or detents for finger fitting.

The gauge or thickness of parts 21 and 23 of key 18 may be greater than the thickness of part 19. Part 19 must be of a thickness equal to the thickness of the keyway 14 such as to provide no wiggle room upon the closure member 18's insertion. The bottom part 19 of the key 18 serves as a shutoff of the fluid flow going from the central opening 16 and through the adjacent O-rings 13, or to shutoff fluid going toward central opening 17 of flange 32 and this bottom part needs to be of a finite thickness. See FIG. 3 wherein central opening 42 of the keyway 14 is closed off. The key employed in this invention is segregable from the keyway. By the term segregable, it is meant that the key may be totally removed from between the flanges, and isolated away from the valve system.

FIG. 4 illustrates the placement of the key 18, and most particularly the lower part 19 between the two O-rings 13. Key 18, which may be a planar member, subject only to thickness variations to the middle and top parts of the closure member; or planar at least as to the utilitarian bottom part, acts almost like a knife in that it squeezes the two O-rings 13 laterally apart in opposite directions upon a thrusting insert, to block the flow of fluid flowing through the central opening 42 of the keyway, flowing in the direction of arrow 38. While shown as a planar member, the key need not be so long as it is of uniform thickness in the bottom part. Contrast FIG. 4 to FIG. 5 where in FIG. 5 the bottom 19 of the key 18 has been removed from between the two O-rings such that fluid can pass, as is depicted by wavy line 39. Note that the width of the middle part of the key may be wider than the bottom part of the key such that upon insertion the bottom edges of the middle part rests respectively on top of one arm of the keyway.

The viewer is now directed to FIG. 6, which is an end view showing the bottom part 19 of the key 18 behind the O-ring 13 such that the path of fluid flow has been closed off. Note that this key embodiment 184 has optionally mirror image fingers 185 to fit exteriorly of keyway 14's arms 14A as is within the scope f the invention.

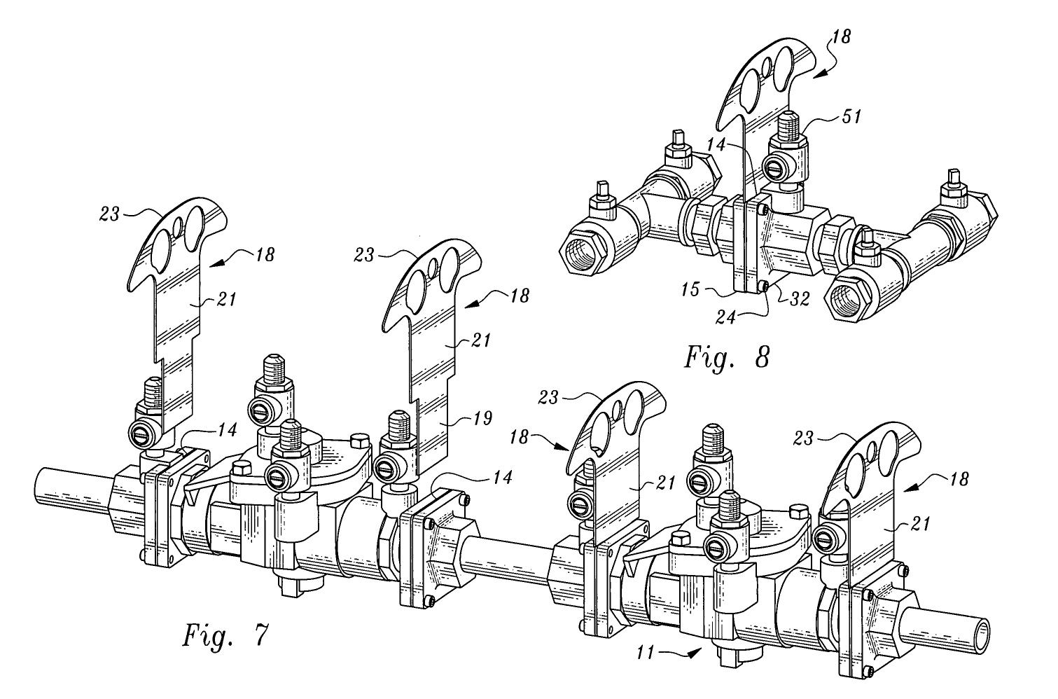

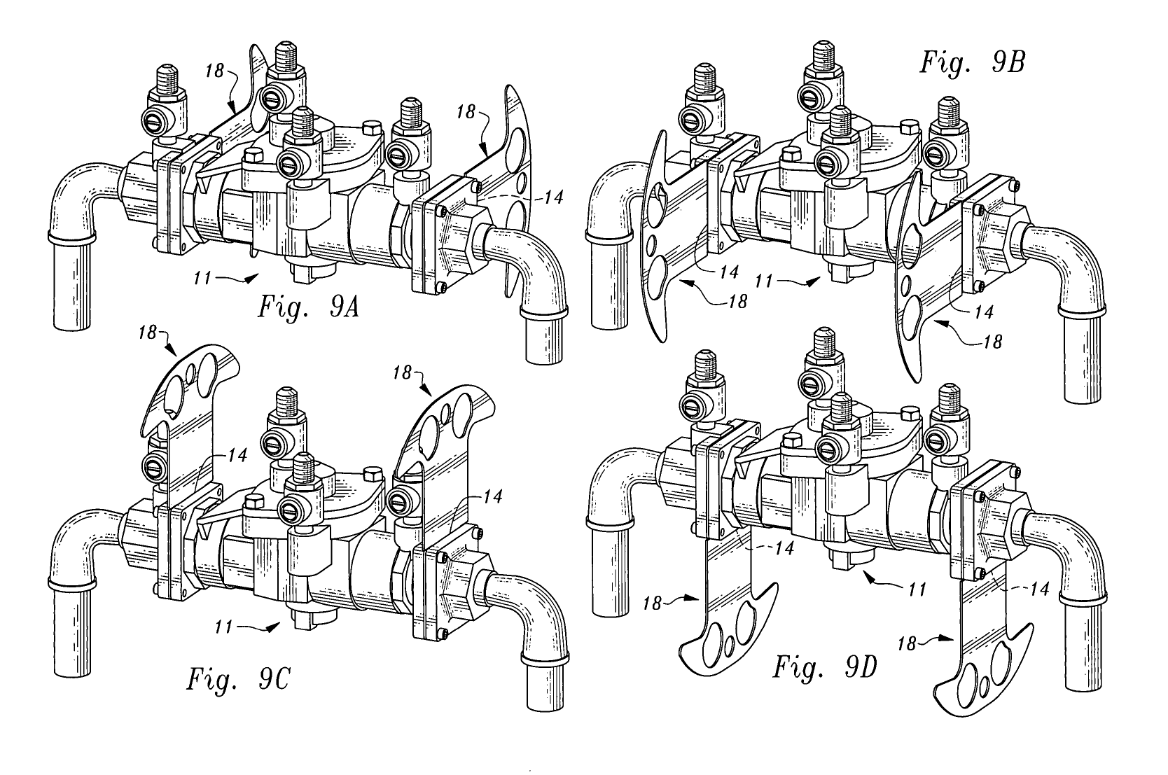

Thus as illustrated in FIG. 7, the shutoff key is either a go or no-go switch. There is no partial opening of the fluid flow with this key because the pressure would just force the key out of the keyway 14 not fully seen, if a user attempted to only partially remove or partially insert the key 18 into or from the keyway. This go-no go concept, IE. totally open-totally closed concept is illustrated in FIG. 7 which illustrates two in-line valves utilizing the closure system of this invention, the left two opened and the right two being closed off.

In FIG. 8, which is a top view of the invention of this application incorporated into a fluid flow control situation, the thinness of the key 18 is seen in this perspective view. The two flanges 32 and 15 are also shown. Of course the O-rings and keyway are internal and unseen. This figure further illustrates the fact that the application finds utility in small fluid flow systems as well as in large systems of more than 2.5 inches in diameter. An optional relief valve 51 is seen in this view as well. The unnumbered aspects of FIG. 8 are deemed conventional. Key 18 may be mounted left, right, up or down, as may be desired due to the use of a square shaped flange which may be oriented in any suitable ninety-degree position. The keyway 14 may be positioned in any of the four quadrant directions as may be desired for easy access to the key 18 for removal.

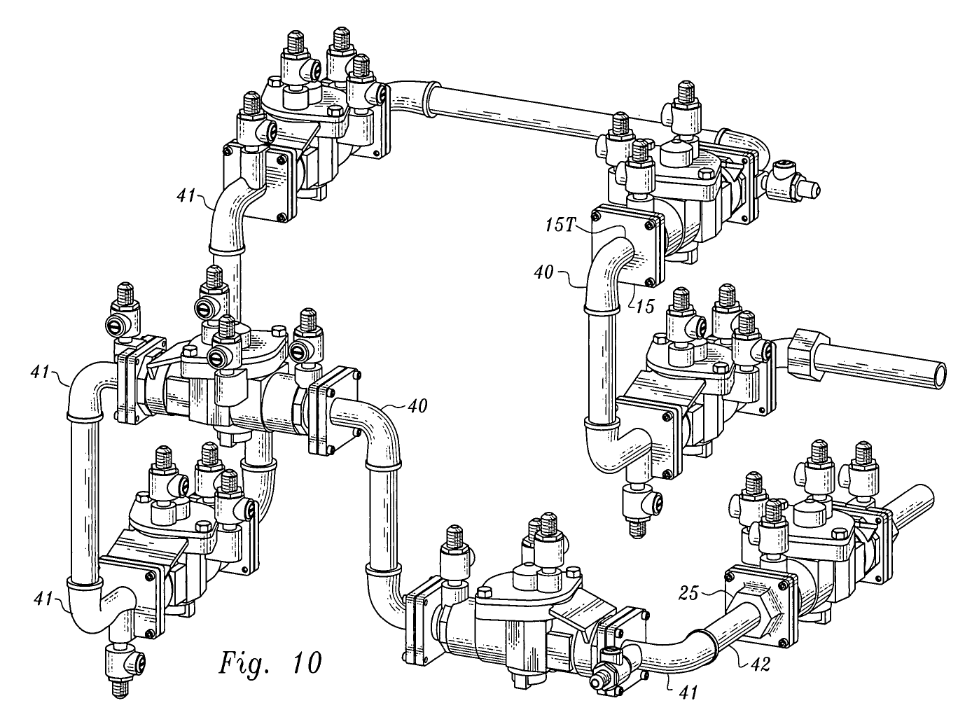

FIG. 10 illustrates the versatility of installation of the invention of this application. As seen in this figure, the termination to replace the nut 25 shown in FIG. 2 may be a threaded elbow 40, engaged to threads 15T of flange 15; or an elbow 41 having a relief valve thereon, or a piece of pipe with a coupling thereon designated 42 among other possible connectors having a thread such as NPT which is known to the plumbing art. Even a PVC joint can be connected between conventional connectors not shown. Note that the FIG. 10 no keys are seen as they have been removed from the premises.

### Large Systems

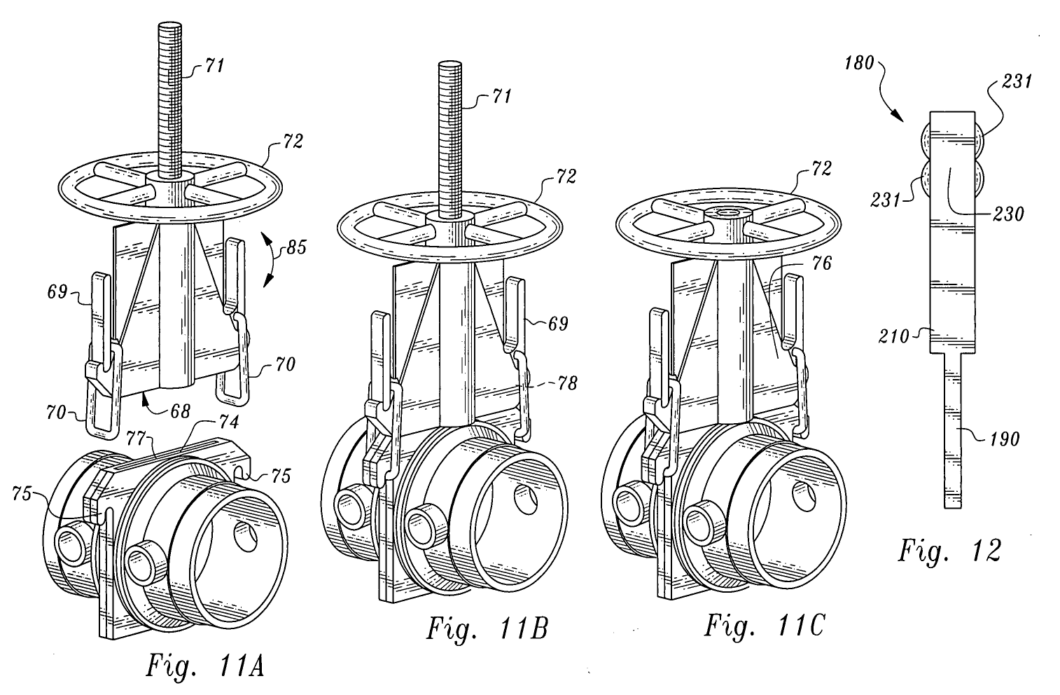

Cities and municipalities require backflow prevention valves to maintain purity of water systems and these systems are usually inspected on an annual basis. In the old days of the prior art, the inspector enters a generally publically non-accessible facility to turn the valve off for testing. Vandalism, pranksters and others can and often do, interfere with the normal operation of certain fluid flow valves. The key system of this invention is readily adaptable to such large systems. Here too, the key is totally segregable. FIGS. 11A, 11B, and 11C illustrate the adaptation of the key in a keyway closure system for large water valve systems utilizing an all open all closed backflow prevention water valve.

As seen in FIG. 11A, a key 68 having a pair of oppositely disposed pivotable members 69 each of which is joined to a hasp ring 70 is positioned over a keyway 74 of the same general internal configuration as the U-shaped keyway 14 previously discussed. Keyway 74 has a pair of opposed ears 75 adapted to receive a respective hasp ring 70, in the same manner one would close a suitcase of the 1940's era. The hasp ring is lowered in position by movement downwardly of the pivotable member 69, and engagement is made as per FIG. 11B. The handle 69 is raised back up and again per movement arrow 85 with the hidden internal key 68 disposed over the slot 77 of the keyway 74. Once positioned in place, the operator turns the wheel 72 on threaded shaft 71 to lower the actual internally hidden closure member 78 attached at the interior end of the shaft 79 into position within the keyway 74. See FIG. 11B. He or she can then wall away with the wheel after rotating it off shaft 71 and not worry about vandalism. Obviously, any other actuator that is segregable may be employed instead of a wheel. Note the location of the shaft 71 in FIG. 11B as contrasted to its position in FIG. 11C. When the shaft 71 is down as in FIG. 11, there is downward tension on the pivotable members 69 and they cannot be easily released.

Thus in both small and large diameter systems, fluid flow will continue at all times until the party having access to a key, picks up a key as from a closet of key ring, and inserts the key into the keyway to shut off the flow.

One big advantage of the invention of this application for use in large systems is that the backflow control can be removed quickly and easily from the line as may be desired without having to disassemble the entire line. This lowers maintenance costs significantly, since in ground components need not be removed.

As is known, backflow control valves are in a normally open position. They are checked annually though sometimes more often. By having a key such as that shown in FIG. 11, the valve allows fluid to flow and is tamper proof from vandals and pranksters. There are no worries about having to fence off the valve, thus reducing maintenance costs. Service is easily accomplished by one person and flow losses are minimized. Flow interruption requires the presence of a service person.

In FIG. 12, an alternate embodiment of the key component of this invention is seen in side elevation. Here the bottom part 190 is of the same finite thickness as the other two parts. However the middle part, the bottom is of which rests of the upper keyway 30 as designated in FIG. 3, is of a greater thickness than the bottom part which fits between the keyway arms 14A and the two touching O-rings 13. The middle part stiffness equals that of the keyway's arms. The top part 230 is seen to be further embellished with the finger fold areas 231 to aid in the insertion of the key 180.

### Second and Third Embodiments

It is to be understood that the invention herein is NOT limited in configuration to flanges having square corners, IE. being either of a square or rectangular configuration. This is illustrated by the presence of the second and third embodiments. The second embodiment is similar to the first in that it utilizes an interposed keyway, but one of the configurations that complements the generally diamond shape of the flanges of this second embodiment. The third embodiment shares the generally diamond configuration of the second embodiment, but utilizes a virtual keyway rather than an actual separate component. The key used for versions (embodiments) 2 and 3 is the same. Of course only one such suitable key has been shown, but other cosmetically different keys are also contemplated. The discussion about finger grips and surface decoration, as well as the use of thicker middle and upper parts of the key—See FIG. 12 and its discussion—is also applicable to the key of the second and third embodiments.

For the sake of ease of understanding the same designation numerals have been used in connection with the discussion of the second and third embodiments as were used with the first embodiment. The prime difference being those parts in the second embodiment have been numbered in the 20s series and parts for the third embodiment have been numbered in the 300s series. The discussion now moves to the second embodiment and the reader is referred to FIGS. 13, 14, 15, and 19.

FIG. 13 is a top sectional view of a pair of flanges of similar configuration, one designated the inner flange 232 shown as the upper unit in this figure and one flange designated the outer flange 215, and shown below flange 232. Thus the first or inner flange has a body 211 which has a central opening 216, and a pair only of bolt holes 220 for the ultimate reception of a bolt such as 24 shown in FIG. 18. The second flange 215 is similarly configured and it too has a pair of throughbores 222 disposed such as to be aligned with the throughbores 220 of it mating flange. Both flanges include tabs 260 having the threaded bores 220,222 and a tubular section 261.

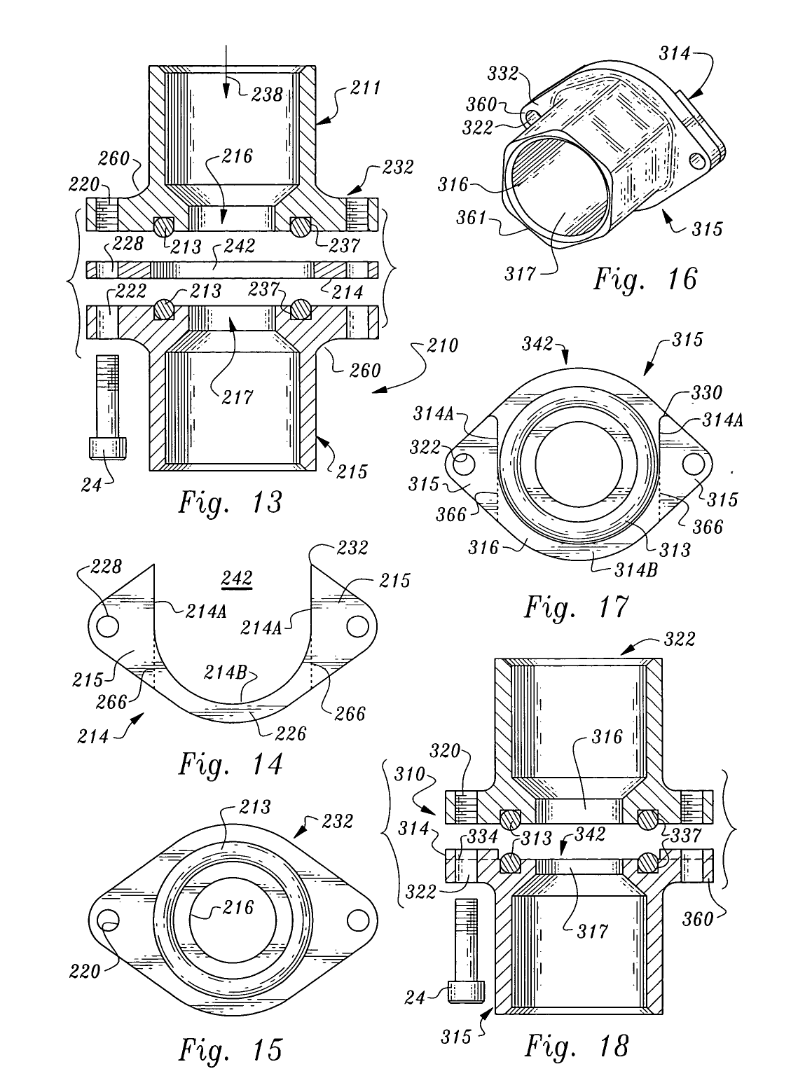

The inner flange 232 has a central opening 216 for fluid flow and flange bores 20 therein. The second, lower flange has an aligned central opening 217 for fluid flow and connecting bores 22 through which a bolt such as 24 shown elsewhere can be disposed. Direction arrow 238 indicates the direction of fluid to be terminated by the key not seen here, in a go-no go valve. For ease of understanding of the FIGURES, the O-ring 313 has been omitted in FIG. 13, but is shown in FIG. 15.

The discussion now moves to FIG. 14, and the keyway 214 to be interposed between the two flanges 215 and 232. Keyway 214 serves the same function as keyway 14 in that it is to be the receptor of the key 218. Keyway 214 is of a configuration externally that matches the generally diamond shape of the second embodiment and is formed of three segments, two sides 215 and a base 226. There is seen to be the outline of a U-shape keyway area within the keyway 214. This U-shape receptor is defined by each of the parallel edges 214A and the interior edge of the base 226, designated 214B. Artificial line shown dotted 266 is the line of separation between the two sides 215 and the base 226. The two sides 215 and the base 226 as a unit are cosmetically crafted to conform to the diamond shape of the two flanges taken in conjunction with the opening 242, which is aligned with the two central openings of the two flanges to be fitted on either side. Each outwardly disposed shoulder 230 serves as a rest for the middle part of a key to prevent over insertion into the keyway 214. Keyway 214 has a pair of throughbores, one on each side set out in an aligned spacing to the threaded bores 220 and 222 to permit the use of bolts 24 for assembly.

Keyway 214 has an open space 242 for receipt of a key such as key 318 seen in FIG. 19. FIG. 15 is an elevational view the interior face of one flange, namely 232 whose exterior configuration matches that of the keyway of FIG. 14. The smooth interior face fits flush against one face of the keyway. Designator 213 is the O-ring, which overlays the central opening 216 of the flange and fits within the space 242 of the keyway 214. Note further that it is permissible to have the diameter f the O-ring to be greater than the width of the opening 242 between the two arms of the keyway. So long as the key separates the two O-rings and the O-rings press against the key in a sealing manner, the fluid flow will be cut off and there will be no leakage.

A key 318, could also be designated 218 as the same key works in both the second and third embodiments. Key 318 has a bottom part 319, which serves to terminate fluid flow; a slightly wider middle section 321 and a handle upper part 323. Three finger holes 367 are seen to make insertion and removal easier. While not specifically shown, the insertion mode of the key of the second embodiment should be quite apparent to those of ordinary skill having read about the mode of insertion for the key for the first embodiment since they are similar.

The reader is now referred to FIG. 16 which depicts in perspective, the outer flange 315 and the inner flange 332 of the third embodiment. In FIG. 16 the nomenclature is retained with the numbers being in the 300s series. Thus the outer flange is numbered 315 but it is the upper flange in the drawing and the inner flange 332 being toward the lower part of the figure. Here too, the body is formed of a tubular section 361 and a pair of mirror image tabs 360. The two central openings are 327 and 316 respectively.

The big distinction between this embodiment and the second embodiment is the elimination of the separate component keyway 214 and its replacement by a “virtual” keyway. The term virtual keyway is employed to indicate that the function of a keyway is present but without the use of an actual interposed component that serves that function as a receptor for the key. Here in the third embodiment, the thickened areas, commonly known as buildup, and designated 314 are disposed on the interior face of each of the tabs 360. The line of demarcation of tab 360 and buildup 314 is shown by the invisible line shown as a dashed line 334 in FIG. 18. FIG. 18 is a sectional top view similar to FIG. 13 which related to the second embodiment.

Refer to FIG. 18, and contrast the inner flange 332 which lacks buildup with the outer flange 315 depicted in the lower position in FIG. 18. These built up zones are also seen in FIG. 17 the elevational view of the interior face of the third embodiment of the outer flange 315. It is again to be noted that the O-ring 313 is again not shown in FIG. 18 such as not to clutter up the figure. However the O-ring is found in FIG. 17, the elevational view. Assembly of one flange to the other is carried out with bolts 24, one of which is shown in FIG. 18, thus creating space 342 into which the key is to be inserted.

As per FIG. 17 which is the interior face of flange 315, the buildup 314 consists of buildup areas 318 the sides and 316 the base. On the sides interior edge 314A and on the base edge 314B define the keyway. The dotted artificial line 360 denotes the separation of the sides 318 from the base 316 of the defined U-shape virtual keyway. Cosmetically the two sides 318 and base 316 for the base are conforming in contour to the balance of the tabs upon which the buildup 314 is overlaid. The buildup acts as a spacer to define the opening 342 located between the parallel edges 314A for the key to be inserted. See FIGS. 17 & 18. Note that in FIG. 18, the segment of the buildup 314 of the base 316 is not viewable.

It is also within the scope of the invention to have buildup on both the inner and outer flanges of the same amount in order to define the keyway. By doing so, only one item needs to be manufactured since they would in fact be mirror images as opposed to two distinct flanges, one with buildup and one without. Either way the buildup defines the space in line with the central openings of the two flanges to serve as a virtual keyway.

Since the ability to insert a key to terminate fluid flow in the same manner and in fact using the same keys suitable for embodiment 2, assuming similar dimensions for the arm and base of the defined u-shape, it is seen that there is shown a virtual keyway without the actual interposed structure.

FIG. 19 illustrates one face of a key 318 suitable for use in the second and third embodiments. The middle part 321's shoulder's 321S rest on outwardly directed edges 330 as seen in FIG. 17 upon insertion into space 342.

Reference is now made to FIG. 22, which is a variant of the embodiment of flange 315, and as such is designated 315-V, for variant. All aspects of the interior face of the flange 315-V are same as the interior face of flange 315 but for the lack of the base buildup 314B. Note the double shoulders 330. Thus it is seen that the buildup 314 consists of merely the two sides 318, with parallel edges 314A defining the open bottomed slot 342V, a variant of the closed bottom keyway of FIG. 17.

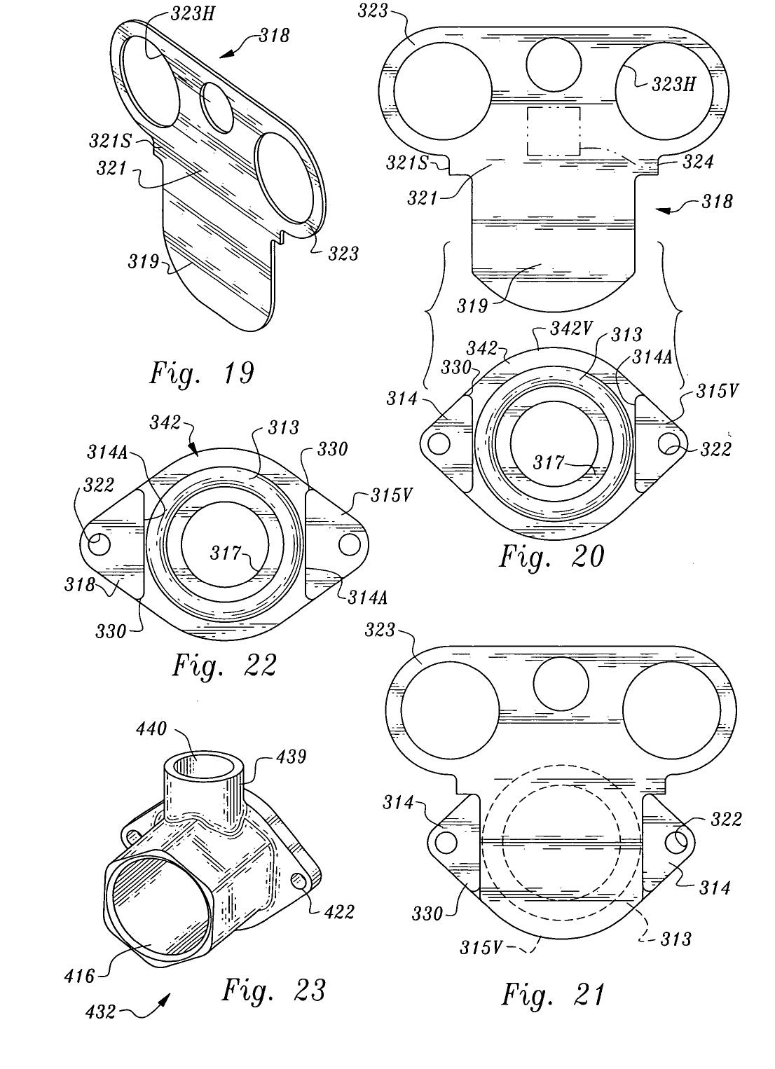

The discussion now turns to the fluid flow stoppage and key insertion for the third embodiment and for the variant of the third embodiment. FIG. 20 shows the opposite face of the key shown in perspective in FIG. 19. This face has a brand or other decorative information, 3, on it in addition to the three finger holes each designated 323H. In this view, the variant flange 315-V is shown and such also is shown in FIG. 21. Note also that the detail of description of the buildup 314 is not shown in these two figures and that only the number 314 is utilized as a general designator for the buildup.

In FIG. 20 the key is yet to be inserted into the open bottom slot between the parallel edges 314A. In FIG. 21, a moment in time later, the key is in the slot or space 342-V, not seen, but easily understood, overlaying the O-rings 313 and disposed between the two O-rings 313. This represents a slight difference from the first embodiment wherein the O-rings are disposed between the parallel arms of the keyway, and do not stick out beyond the edge of the inserted key. Here the key is slightly narrower in width below the shoulders than the two O-rings 313, and as such a bit of the O-ring can be seen in FIG. 21. Note how the shoulder 315 rests on the upper edge 330 of the virtual keyway. In FIG. 21 the key is seen disposed above the flange, but since travel is limited only by the shoulders, 316, and not by the base of the virtual keyway—as is present in FIG. 17, the key in FIGS. 20 and 21 can be inserted upwardly from the bottom if space is a limiting factor.

In FIG. 23, a special flange 432 is seen. No further discussion of the flange aspect of this flange is necessary as it is similar to flange 332 and 232, but for the presence of the extra port 439 having an opening 440 to allow for the insertion of a test cock, not seen, as is known in the art and required in back flow prevention valve systems. The two side tabs thereof are each designated 422 and the central opening is numbered 416.

seals would use a different cross section as the best mode for the recess in which to dwell.

In the discussion of figures such as 2, 5, 16, 18 a resilient seal, which in the text supra has been recited as being an O-ring is seen and described. Any suitable compressive resilient seal may be employed in addition to a conventional O-ring. For example, the resilient seal sold under the brand name Quad-Seal™ may be employed among others. What ever sealing means with a center opening is to be used, the compressive seal chosen must set into a seat or recess circumscribing the central opening of the respective flange. Designators 37, 237 and 337 are the numerals applied to the square shape recesses in the respective flanges utilized as the seat for an O-ring. type seal. Other compressive annular seals employed will have other cross section best configurations for the recesses. The recess cross section determination is with in the skill of the art.

As can be seen from the plethora of shapes and configurations that the instant invention can assume, basically the invention comes down to a fluid flow control assembly (valve system) having a fluid isolation or fluid interruption capability, of a total on-total off nature. A keyway, real or virtual is positioned between two opposed flanges each of which has a seat (recess) in which is disposed a compressive seal seated therein. The pressure exerted on the seals causes them to interface in a leakproof manner such that fluid flow continues through their central opening as is desired without leaking. But when the key is placed into the keyway, between the two O-rings or other compressive seal employed, the seals are placed under additional pressure, in the direction of the seat or recess, one leftwardly and one rightwardly. The key being a planar member of finites thickness—the exact thickness being within the skill of the art to determine based on the size of the seals among other factors, —interrupts the fluid flow by acting as a barrier disposed between the two compressive seals.

It is seen that I have provided a new class of a shutoff mechanism for valves in general and for backflow control valves in particular. Other modifications of this invention are readily anticipated and are within the skill of the art. For example, while the discussion has disclosed the use of a square keyway and oppositely disposed preferably square flanges on opposite sides of the keyway, a generally rectangular keyway with matching rectangular flanges may also be employed for the first embodiment. The down side to such is the lack of the level of spatial versatility during installation situations as is possible with the square shape. It is also seen that neither the flanges, nor the keyway need to be of any specific configuration. Witness the fact that the second and third embodiments are generally diamond in shape for the flange unit while utilizing a generally rectangular keyway in the second embodiment. In fact no actual component of a key way is necessary as is seen by embodiment 3 which utilizes a virtual keyway. This virtual keyway may be generally U-shaped or a mere slot may be employed for key insertion. What is a common theme throughout this invention is the use of a pair of opposed similar annular seals under pressure to create a sealed zone through which fluid passes, until a key is interposed between the seals to shut off the flow of fluid. Being under pressure from the flanges in which they are seated, prior to key insertion, the O-rings, Quad-seal or the like are under greater pressure once the key is interposed between them.

One can conclude therefore that while any cross sectional shape could be utilized as an equivalent to an O-ring in this environment, from a practical sense O-rings are the most readily available seal in the marketplace. It may also be concluded that the key need not be square or rectangular, but merely one that conforms to the shape of the slot or space within a keyway to overlay and separate the pair of O-rings. Thus a diamond shaped or even a star-shaped key among other shapes are well within the scope of this invention, if they are correctly sized to perform the function needed of stopping fluid flow on a go-no go basis.

Since certain changes may be made in the described apparatus without departing from the scope of the invention herein involved, it is intended that all matter contained in the above description and shown in the accompanying drawings shall be interpreted as illustrative and not in a limiting sense.

1. A new totally open-totally closed valve closure device suitable for backflow prevention which comprises:
a. a keyway fixedly disposed between two flanges, each one of the flanges has a central opening through which fluid can flow,
b. a pair of annular compressive seals disposed within the keyway and seated one each at each flange's central opening and said seals being in contact with each other for leakproof flow,
c. a segregable key having a finite thickness bottom part, said bottom part sized to fit within the keyway in a first direction, and sized to fit between the two seals to segregate contact between the seals to thereby terminate fluid flow when fluid is passing from one flange to the other.

2. A device suitable for backflow prevention, according to claim 1 wherein the keyway comprises:
a U-shaped keyway having two upstanding arms, said keyway having suitably spaced throughbores in the arms thereof, and having a finite thickness, for a bolted disposition between opposed bored flanges,
and the compressive seals are a pair of O-rings disposed between the arms of the keyway and across the keyway opening in contact with each other,

3. The valve closure device of claim 2 wherein the two upstanding arms of the keyway are of the same elevation as the length of the base to define a square shaped opening between the arms and base of the keyway.

4. A new valve for fluid flow control having a totally open-totally closed closure which valve comprises:
a. a valve body having a pair of equal mirror image flanges facing each other, each of said flanges having a central opening for fluid flow,
b. an O-ring disposed in a recess across the opening of each flange, said O-rings being sized to have a diameter equal to or lesser than the diameter of an interposed keyway,
c. a keyway interposed between the two flanges, and having said O-rings disposed between said arms and in intimate contact with the other O-ring,
d. a segregable key having a uniform thickness bottom part insertable within the keyway and being of a lateral dimension slightly smaller than the lateral dimension of the keyway whereby upon insertion of said key, the contact between said O-rings is terminated and the bottom part of said key separates one O-ring from the other to prevent fluid flow from one flange's central opening to the other flange's central opening.

5. The valve of claim 4 wherein the flanges are square shape and the keyway has arms of an elevation equal to the length of the base to define a square opening with the keyway.

6. The valve closure of claim 1 wherein the key has a middle part of greater diameter than the bottom part and the seals are seated in suitably configured recesses surrounding the respective central openings.

7. The valve closure of claim 2 wherein the key has a middle part of greater diameter than the bottom part.

8. The valve of claim 4 wherein the key has a middle part of greater diameter than the bottom part, and has a handle disposed above the middle part, whereby upon insertion of the bottom part into the keyway, the middle part remains external and rests on the edge of the keyway.

9. The valve closure of claim 7 wherein the key further includes a handle part above the middle part and the flanges are of a shape other than square cornered.

10. The valve closure of claim 1 wherein the key further includes a decorative handle part, a middle part and the aforementioned bottom part, and at least said handle is of a greater thickness than said bottom part.

11. The valve of claim 8 wherein the valve has flanges that are generally diamond shape.

12. The valve closure of claim 1 wherein the middle part of the segregable key has a thickness greater than the thickness of bottom part and the lateral extension of the middle part is greater than the lateral extension of the bottom part.

13. The valve closure of claim 1 wherein the middle and top parts of the key are laterally greater than the bottom part of the key that fits in the keyway.

14. The valve of claim 4 wherein the key has three parts, a decorative handle part, a middle part and a bottom part, and wherein the handle and middle parts are laterally greater in extension than the bottom part which fits in the keyway.

15. The valve of claim 14 wherein the flanges and the interposed keyway are bolted together.

16. The valve of claim 4 wherein the flanges are two equal square corner flanges are generally square shaped and the keyway disposed there between is generally square shaped.

17. The valve of claim 16 wherein each flange is threadedly bored at each corner and the keyway is bored to be bolted between the two flanges.

18. A process for preventing fluid flow in a backflow prevention valve body having a pair of mirror image flanges each with a central opening therein, connected to each other which process comprises:
a. separating the two connected flanges, and placing an O-ring across the central opening of each flange, if none is present,
b. interposing a U-shaped keyway having two spaced arms between the flanges,
c. positioning the O-rings for sealing contact with each between the two arms of the keyway,
d. connecting the keyway fixedly to the flanges,
e. inserting a segregable key having a uniform thickness bottom part into the keyway to separate the two O-rings and to thereby prevent fluid flow from one flange to the other flange.

19. A process for terminating fluid flow in a fluid pipeline which process comprising:
a. separating one portion of the pipeline from another,
b. attaching a pair of mirror image flanges having a central opening, one flange on each end of the separated pipeline,
c. placing an O-ring across each of the central openings sized to fit between the arms of a keyway,
d. fixedly attaching a keyway between each of the two flanges,
e. maintaining the O-rings intimate contact with each other between the arms of the keyway,
f. inserting a is segregable key of a finite thickness into the keyway between the O-rings to prevent fluid flow.

20. A process for interrupting fluid flow in a flow control assembly, which process comprises:
a. attaching a pair of mirror image flanges having a central opening, on one end of the flow control assembly,
b. placing an annular compressive seal across each of the central openings of said flanges,
c. maintaining said seals compressed against each other to prevent leakage at the interface of the two seals,
d. fixedly providing a keyway between the two flanges, for receipt of a uniform thickness key, and the interface of the two seals;
e. inserting a segregable key of a finite thickness into the keyway between the seals to interrupt/prevent fluid flow.

21. A new totally open-totally closed valve closure device suitable for backflow prevention which comprises:
a. a U-shaped keyway having two upstanding spaced arms fixedly disposed between two flanges, each one of the flanges has a central opening through which fluid can flow,
b. a pair of O-rings disposed internal of the two arms of the U-shaped keyway and seated one each at each flange's central opening and said O-rings being in contact with each other for leakproof flow,
c. a segregable key having a uniform thickness bottom part with two parallel sides, said bottom part sized to fit between the two upstanding arms of the keyway in a first direction, and sized to fit between the two O-rings to segregate contact between the O-rings to thereby terminate fluid flow when fluid is passing from one flange to the other.

22. The device of claim 1 wherein the keyway is a U-shaped keyway having two upstanding parallel arms, and the bottom part of the key has two parallel sides.

23. The device of claim 22, wherein the compressive seals are O-rings.

24. The device of claim 1 wherein the keyway is a virtual keyway defined by buildup disposed on at least one of the flanges to create a space to serve as a keyway in line with the central openings of the two opposed flanges.

25. The valve of claim 4 wherein the valve further includes a test cock as required for back flow prevention.

26. The valve of claim 4 wherein the two flanges have generally square corners, and the keyway disposed between said flanges is U-shaped having two upstanding arms and a base.

27. The valve of claim 4 wherein the keyway is defined by one of said flanges having a built up area to create a space between said flanges aligned with the central openings of said flanges, said space being a virtual keyway.

28. The valve of claim 4 wherein the key is structurally internal at all times and is connected by a threaded rod to a removable wheel used to raise and lower the key into position in front of the central openings of the flanges.

29 The valve of claim 26 wherein the key has a middle part of greater diameter than the bottom part, whereby upon insertion of the bottom part into the keyway, the middle part rests on the upper edge of each arm of the keyway.

30. The valve of claim 4 wherein each flange is generally diamond shaped and the keyway disposed there between is a diamond shaped element having two interior vertical parallel edges, for the receipt of a segregable key having two square corners at the bottom of its lower part.

31. A fluid control assembly comprising at least one fluid isolation device, which device comprises:
a. a pair of aligned opposed flanges, each of which has a central opening for the flow of fluid, and each has a recess for the receipt of a seal circumscribing said central opening,
b. a pair of mating seated resilient annular seals, each disposed within the recess of a respective flange
c. said flanges being connected to each other and having a keyway there between and said seals also being in intimate contact with each in said keyway, to prevent leakage of any flowing fluid,
d. a segregable key of finite thickness, sized and shaped to fit into said keyway,
whereby upon insertion of said key into said keyway, the key causes the separation of said seals, a blockage of the central openings of said flanges and termination/prevention of fluid flow from one flange to the other.

32. The valve of claim 26 wherein the seals are O-rings disposed laterally between the arms of said U-shaped keyway.

33. The valve of claim 4 wherein the O-rings are replaced by a Quad-seal™ seal disposed in a suitable recess.

34. In the fluid control assembly of claim 31 wherein the flanges are diamond shaped, and the keyway is a virtual keyway, and the key has a bottom part and said bottom part is the only part of said key that fits into said keyway.

35. In the fluid control assembly of claim 31 wherein the flanges are diamond shaped, and the keyway is a separate interposed component disposed between said flanges.

36. In the fluid control assembly of claim 35 wherein the flanges each have a shoulder, and the key has a middle part and a bottom part and said middle part is of greater lateral extension than the bottom part whereby the middle part rests on the shoulders of said flanges when said bottom part is inserted into the keyway.

37. In the fluid control assembly of claim 34 wherein said virtual keyway is defined as both open topped and open bottomed such that the key may be inserted into said virtual keyway from either of two directions.

38. The valve closure device of claim 1 wherein the segregable key is configured to conform to the shape of the keyway, and the bottom part of said key is of a uniform thickness.

39. The process of claim 19 wherein the keyway attaching step comprises attaching a U-shaped keyway between the flanges.
